(19) United States
(12) Patent Application Publication
(10) Pub. No.: US 2012/0137426 A1
(43) Pub. Date: Jun. 7, 2012

(54) Automatic water flow controller for faucet

(76) Inventor: Hsiang Hung Wang, Changhua Hsien (TW)

(21) Appl. No.: 12/928,220

(22) Filed: Dec. 7, 2010

(51) Int. Cl. E03C 1/05; F16K 31/02

(52) U.S. Cl. 4/623; 251/129.04

(57) ABSTRACT

An automatic water flow controller includes a detecting device coupled to a processing device for detecting an approaching of a user, a control device having a control valve coupled to a water supplying pipe, an electric energy storing device having a capacitor coupled to the control device, and an electric generating device having an electric generator coupled to the water supplying pipe for being actuated by the water to generate and supply an electric energy to charge the capacitor, the processing device actuates the control valve to open the water supplying pipe and to operate the electric generating device and to generate the electric energy when a voltage in the capacitor is less than a predetermined value.

### BACKGROUND OF THE INVENTION

1. Field of the Invention

The present invention relates to an automatic water flow controller for a faucet, and more particularly to an automatic water flow controller for automatically controlling a faucet to deliver the water when detecting an approaching of a user to the faucet without batteries.

2. Description of the Prior Art

Typical automatic water flow controllers comprise a control mechanism for automatically controlling a faucet to deliver the water for a predetermined time interval and for flushing or cleaning purposes.

For example, U.S. Pat. No. 4,335,852 to Chow, and U.S. Pat. No. 4,562,865 to Lemkin et al. disclose two of the typical fluid flow controlling devices including a timed water shut-off device for controlling the faucet to deliver the water for a predetermined time interval.

However, normally, the typical fluid flow controlling devices comprise a complicated structure and are controlled manually and may not automatically control the faucet to deliver the water when a user approaches to the faucet.

U.S. Pat. No. 5,979,776 to Williams disclose another typical water flow and temperature controller for a bathtub faucet including a panel surrounds the standard bath tub water valves, and a control assembly within the panel is communicative with the temperature sensors in the shower head and the bath tub faucet as well as control valves on the hot and cold water supply lines.

However, similarly, the typical water flow and temperature controller is controlled manually and may not automatically control the faucet to deliver the water when a user approaches or moves close to the faucet. In addition, an additional battery or power supply is further required to be provided and attached or coupled to energize the typical water flow and temperature controller and will be consumed quickly and should be replaced or changed with the new ones often.

The present invention has arisen to mitigate and/or obviate the afore-described disadvantages of the conventional automatic water flow controllers for faucets.

### SUMMARY OF THE INVENTION

The primary objective of the present invention is to provide an automatic water flow controller for a faucet and for automatically controlling a faucet to deliver the water when detecting an approaching of a user to the faucet.

The other objective of the present invention is to provide an automatic water flow controller for a faucet including a water actuated or operated electric generator for generating the electric energy to energize the water flow controller without batteries.

The further objective of the present invention is to provide an automatic water flow controller for a faucet including a capacitor for storing the electric energy.

In accordance with one aspect of the invention, there is provided an automatic water flow controller comprising a water supplying pipe for receiving a water, a faucet coupled to the water supplying pipe for selectively discharging the water, a processing device, a detecting device coupled to the processing device for detecting whether a user approaches to the faucet or not, a control device including a control valve coupled to the water supplying pipe for selectively controlling the water to flow through the water supplying pipe and to the faucet, an electric energy storing device including a capacitor coupled to the control device, and an electric generating device including an electric generator coupled to the water supplying pipe for being actuated by the water flowing through the water supplying pipe and for generating an electric energy and for supplying the electric energy to the capacitor and to energize the electric parts or elements of the water flow controller without batteries.

The capacitor is coupled to the processing device, and the processing device actuates the control valve to open the water supplying pipe and to operate the electric generating device to generate the electric energy and to supply the electric energy to the capacitor when a voltage in the capacitor is less than a predetermined value.

The water supplying pipe includes a first manifold tube and a second manifold tube, and the control valve is coupled to the first manifold tube of the water supplying pipe, and a manual valve is coupled to the second manifold tube for controlling the water to selectively flow through either of the manifold tubes and to the faucet.

The processing device actuates the control valve to open the water supplying pipe and to operate the electric generating device to generate the electric energy and to supply the electric energy to the capacitor when a voltage in the capacitor is less than a predetermined value.

The control valve of the control device includes a coil, and includes an operating circuit coupled to the processing device and coupled to the coil for allowing the coil to be actuated and operated by the processing device.

The electric generating device includes a rectifier coupled to the electric generator, and a first diode coupled between the rectifier and the capacitor for supplying the electric energy to the capacitor, and includes a stabilizing diode coupled between the rectifier and the first diode for preventing the capacitor from being damaged or over charged.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating an electric circuit of an automatic water flow controller for a faucet in accordance with the present invention;

FIG. 2 is another plan schematic view similar to FIG. 1, illustrating the other arrangement of the automatic water flow controller; and

FIG. 3 is a further partial plan schematic view illustrating the arrangement of the automatic water flow controller for the faucet or the like.

### DETAILED DESCRIPTION OF THE PREFERRED EMBODIMENT

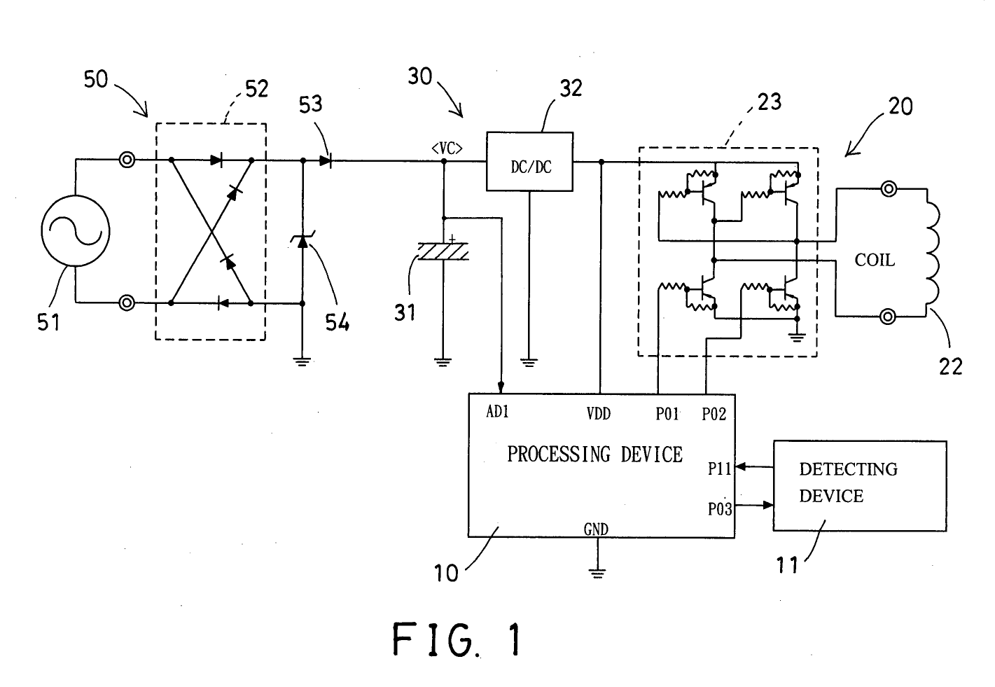

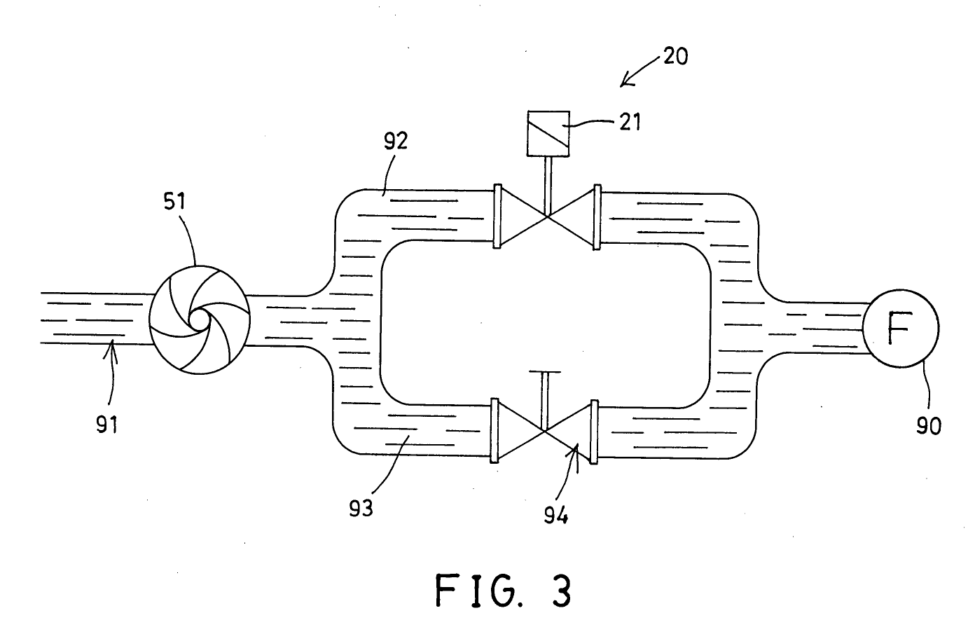

Referring to the drawings, and initially to FIG. 1, an automatic water flow controller for a faucet in accordance with the present invention comprises a controlling device or microprocessor or processing device 10, and a detecting device 11 coupled to two contacts or terminals P11 and P03 of the processing device 10 for detecting whether a user approaches to the faucet 90 (FIG. 3) or not and for sending the detected signal to the contact or terminal P11 of the processing device 10 in order to actuate or operate the processing device 10 to control the faucet 90 to deliver the water when a user has been detected to be approached or moved close to the faucet 90.

As shown in FIG. 3, the faucet 90 is attached or mounted or secured or coupled to a water supplying line or pipe 91 which includes two manifold tubes 92, 93, and the water flow controller in accordance with the present invention comprises a manual valve 94 attached or coupled to one of the manifold tubes 93 for controlling the water to selectively flow to the faucet 90, and an automatic control device 20 attached or coupled to the other manifold tube 92 and for controlling the water to selectively flow to the faucet 90 without flowing through the manual valve 94. For example, the automatic control device 20 includes a solenoid control valve 21 attached or mounted or connected or coupled to the water supplying line or pipe 91 or to the other manifold tube 92 of the water supplying line or pipe 91 for selectively controlling the water to flow to the faucet 90.

As shown in FIG. 1, the solenoid control valve 21 of the automatic control device 20 includes a coil 22 for controlling or for shutting off or for opening the manifold tube 92, and a bridge circuit or solenoid operating circuit 23 coupled to the processing device 10 at two contacts or terminals P01 and P02 and also coupled to the coil 22 for allowing the coil 22 to be actuated or operated by the processing device 10 through the solenoid operating circuit 23. For example, when the contact or terminal P01 is at a Hi value or voltage, the operating circuit 23 will be actuated or operated or energized. On the contrary, when the other contact or terminal P02 is at a Hi value or voltage, the operating circuit 23 will be closed or switched off. The required electric current for the operating circuit 23 is much greater than that for the processing device 10 and the detecting device 11.

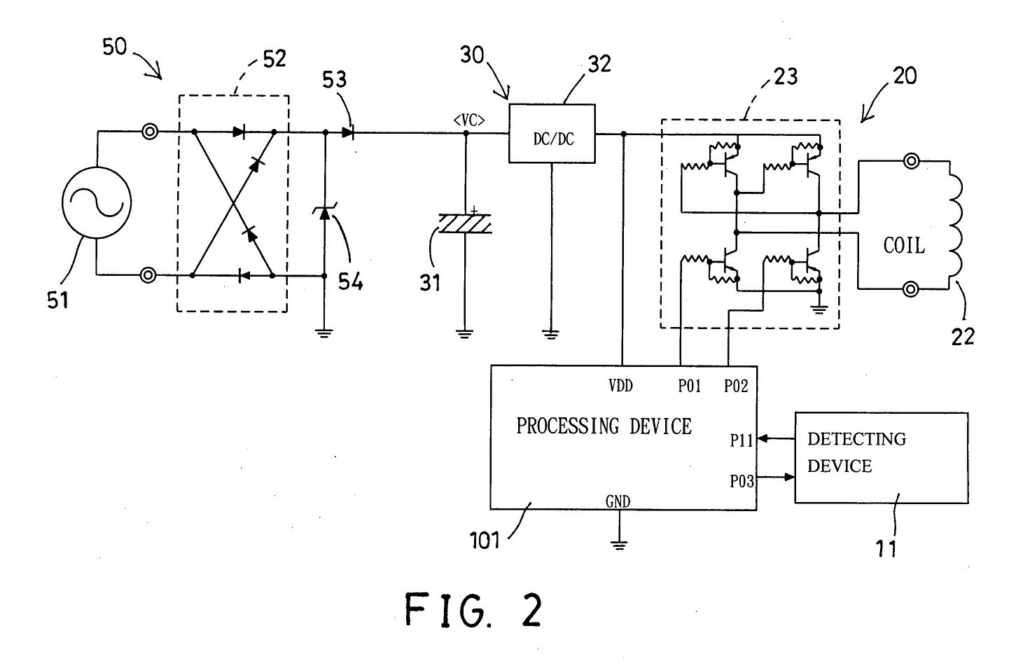

An electric energy receiving and storing device 30 includes a capacitor 31 and/or a voltage transforming circuit 32 coupled in series to the operating circuit 23 for receiving and storing the electric energy and for supplying the electric energy to energize the processing device 10, the detecting device 11, the solenoid control valve 21, and/or the solenoid operating circuit 23. The capacitor 3.1 may also be directly coupled to the operating circuit 23 of the automatic control device 20 without the voltage transforming circuit 32, and may be selectively and electrically coupled to the processing device 10 at a contact or terminal AD1 for detecting whether the voltage VC in the capacitor 31 is greater than a predetermined voltage or value or not. Alternatively, as shown in FIG. 2, the capacitor 31 may also not be coupled to the processing device 101.

The water flow controller in accordance with the present invention further comprises an electric generating device 50 including a hydraulic or water actuated or operated electric generator 51 attached or mounted or secured or coupled to the water supplying line or pipe 91 for being actuated or operated with or by the water flowing through the water supplying line or pipe 91 and for generating the electric energy and for supplying the electric energy to the capacitor 31, to energize the electric parts or elements of the water flow controller without batteries, and the electric generating device 50 includes a rectifier 52 coupled to the electric generator 51, and a diode 53 coupled between the rectifier 52 and the capacitor 31 for suitably charging or supplying the electric energy to the capacitor 31.

The electric generating device 50 may further include a stabilizing diode 54 coupled between the rectifier 52 and the diode 53 for preventing the output from the rectifier 52 to over energize or charge the capacitor 31 and for protecting the capacitor 31 from being damaged or over charged, and the diode 53 may prevent the capacitor 31 from discharging the electric energy when the stabilizing diode 54 is leaking or has an electric energy leaking problem.

In operation, as shown in FIGS. 1 and 3, when the faucet 90 is switched on or actuated or operated wither manually with the manual valve 94 or automatically with the solenoid control valve 21 of the automatic control device 20, and when the water flows through the water supplying pipe 91, the electric generator 51 may be actuated or operated with or by the water flowing through the water supplying pipe 91 in order to generate the electric energy and to supply the electric energy to the capacitor 31 and so as to energize the electric parts or elements of the water flow controller without batteries, and the processing device 10 may actuate or operate the coil 22 of the automatic control device 20 to selectively open the manifold tube 92 and to selectively deliver the water to the faucet 90 when the detecting device 11 has detected that a user approaches to the faucet 90.

In addition, when the voltage VC in the capacitor 31 is smaller or less than a predetermined voltage or value, the processing device 10 may also actuate or operate the coil 22 of the automatic control device 20 to selectively open the manifold tube 92 and to have the electric generator 51 to be actuated or operated with or by the water flowing through the water supplying line or pipe 91 and to generate the electric energy and to supply the electric energy to charge the capacitor 31. Alternatively, as shown in FIG. 2, the voltage VC in the capacitor 31 may be gradually decreased due to the leaking or consuming of the electric energy with or by the electric parts or elements of the water flow controller; and when the voltage VC in the capacitor 31 is smaller or less than a predetermined voltage or value, the processing device 101 may also actuate or operate the coil 22 of the automatic control device 20 to selectively open the manifold tube 92 and to have the electric generator 51 to be actuated or operated with or by the water flowing through the water supplying line or pipe 91 and to generate the electric energy and to supply the electric energy to charge the capacitor 31.

For example, for or after a predetermined time interval, the processing device 101 may actuate or operate the coil 22 of the automatic control device 20 to selectively open the manifold tube 92 and to have the electric generator 51 to be actuated or operated with or by the water flowing through the water supplying line or pipe 91 and to generate the electric energy and to supply the electric energy to charge the capacitor 31 and to maintain the voltage VC in the capacitor 31 at a higher voltage or value than the predetermined voltage or value. The predetermined time interval is set or determined between two flushing operations, and may be determined by the time that the electric parts or elements of the water flow controller consume the electric energy of the capacitor 31.

Accordingly, the automatic water flow controller for a faucet in accordance with the present invention may be provided for automatically controlling a faucet to deliver the water when detecting an approaching of a user to the faucet, and includes a water actuated or operated electric generator for generating the electric energy to energize the water flow controller without batteries, and includes a capacitor for receiving and storing the electric energy.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An automatic water flow controller comprising:
a water supplying pipe for receiving a water,
a processing device,
a detecting device coupled to said processing device for detecting a user approaching,
a control device including a control valve coupled to said water supplying pipe for selectively controlling the water to flow through said water supplying pipe,
an electric energy storing device including a capacitor coupled to said control device, and
an electric generating device including an electric generator coupled to said water supplying pipe for being actuated by the water flowing through said water supplying pipe and for generating an electric energy and for supplying the electric energy to said capacitor.

2. The automatic water flow controller as claimed in claim 1, wherein said capacitor is coupled to said processing device, and said processing device actuates said control valve to open said water supplying pipe and to operate said electric generating device to generate the electric energy and to supply the electric energy to said capacitor when a voltage in said capacitor is less than a predetermined value.

3. The automatic water flow controller as claimed in claim 1, wherein said water supplying pipe includes a first manifold tube and a second manifold tube, and said control valve is coupled to said first manifold tube of said water supplying pipe, and a manual valve is coupled to said second manifold tube.

4. The automatic water flow controller as claimed in claim 1, wherein said processing device actuates said control valve to open said water supplying pipe and to operate said electric generating device to generate the electric energy and to supply the electric energy to said capacitor when a voltage in said capacitor is less than a predetermined value.

5. The automatic water flow controller as claimed in claim 1, wherein said control valve of said control device includes a coil.

6. Said automatic water flow controller as claimed in claim 5, wherein said control valve of said control device includes an operating circuit coupled to said processing device and coupled to said coil for allowing said coil to be actuated and operated by said processing device.

7. The automatic water flow controller as claimed in claim 1, wherein said electric generating device includes a rectifier coupled to said electric generator, and a first diode coupled between said rectifier and said capacitor for supplying the electric energy to said capacitor.

8. The automatic water flow controller as claimed in claim 7, wherein said electric generating device includes a stabilizing diode coupled between said rectifier and said first diode for preventing said capacitor from being over charged.
